(19) United States
(12) Patent Application Publication
(10) Pub. No.: US 2024/0192848 A1
(43) Pub. Date: Jun. 13, 2024

(54) MANAGEMENT COMPUTER AND MANAGEMENT METHOD FOR STORAGE SYSTEM

(71) Applicant: Hitachi, Ltd., Tokyo (JP)

(72) Inventors: Tsukasa SHIBAYAMA, Tokyo (JP); Kenta SATO, Tokyo (JP); Akira DEGUCHI, Tokyo (JP)

(73) Assignee: Hitachi, Ltd., Tokyo (JP)

(21) Appl. No.: 18/241,347

(22) Filed: Sep. 1, 2023

(30) Foreign Application Priority Data
Dec. 9, 2022 (JP) 2022-197366

(51) Int. Cl. G06F 3/06

(52) U.S. Cl. CPC G06F 3/0604; G06F 3/0655; G06F 3/0673

(57) ABSTRACT

A management computer receives designation of an operation content and an operation target resource from a management user of a first type (managed or self). In a case where the operation target resource is a system resource managed by a management user of a second type (self or managed) and an operation according to the operation content for the operation target resource influences storage management by the management user of the second type, the management computer changes an authority of an operation regarding an influence for the management user of the second type to an authority not to influence an environment realized by construction including performing an operation according to the operation content for the operation target resource, and then performs the operation according to the operation content for the operation target resource.

### BACKGROUND OF THE INVENTION

### 1. Field of the Invention

The present invention generally relates to a management technique of a storage system.

### 2. Description of the Related Art

As system resources which are resources of a storage system, there are various physical or logical system resources such as ports and logical volumes. For example, techniques disclosed in JP 2003-330622 A and U.S. Pat. No. 7,152,079 B have been known as techniques using the system resources.

### SUMMARY OF THE INVENTION

The storage system may be a system including one or more physical or logical storage devices. At least one storage device may include one or a plurality of physical or logical general-purpose computers. Further, in at least a part of the storage system, each of one or more physical computers may execute predetermined software, and thus, the one or more physical computers may be constructed as software-defined anything (SDx). For example, a software-defined storage (SDS) or a software-defined data center (SDDC) can be adopted as the SDx.

Further, as management services of the storage system, there are self services and managed services.

The “self service” is a service in which a purchaser (for example, a company) or a user of the storage device manages the storage device. In the self service, it is necessary for the purchaser or the user to grasp a detailed configuration of the storage device. Hereinafter, management in the self service may be referred to as “self-management”, and a person who performs the self-management may be referred to as “self-management user”. The “management user” is a person who manages the storage device. The self-management user is a purchaser or a user of the storage device, or a person belonging to the purchaser or the user (for example, an employee of the purchaser or the user).

On the other hand, the “managed service” is a service in which a vendor of the storage device manages the storage device. In the managed service, a system resource (for example, a logical volume) required by the user of the storage device is provided, and the user does not need to grasp the detailed configuration of the storage device. Hereinafter, management in the managed service may be referred to as “managed management”, and a person who performs the managed management may be referred to as a “managed management user”. The managed management user is a vendor of the storage device or a person belonging to the vendor (for example, an employee of the vendor).

In an environment in which the self service and the managed services are mixed, there may be a system resource that can be an operation target in the self-management and an operation target in the managed management. For example, in recent years, a cloud storage device (cloud computing service-based storage device) is adopted as at least a part of the storage system, and it is conceivable to transition from an on-premises storage device to a cloud storage device. An operation environment for realizing the transition may include a system resource that can be the operation target in the self-management and the operation target in the managed management. In this case, when such a system resource is operated by one management user of the self-management user and the managed management user, an unintended influence of the other management user may occur (for example, an environment intended by the other management user is unintentionally broken, and/or the other management user cannot construct an environment having a desired configuration in the future).

The management computer retains, for each management user, user management information indicating whether a type of the management user is the self-management user or the managed management user, and resource management information indicating which management user manages and whether or not to perform the managed management for each system resource. The management computer receives designation of an operation content and an operation target resource from a management user of a first type (managed or self). In a case where the management computer specifies that the operation target resource is a system resource managed by a management user of a second type (self or managed) from the user management information and the resource management information and specifies that an operation according to the operation content of the operation target resource influences storage management by the management user of the second type, the management computer changes an influence operation authority that is an authority of an operation regarding an influence for the management user of the second type to a maintaining contribution authority that is an authority to contribute to maintaining of an environment realized by construction including performing the operation according to the operation content for the operation target resource and then performs the operation according to the operation content for the operation target resource.

According to the present invention, it is possible to prevent the occurrence of the unintended influence of one of the self-management user and the managed management user due to the resource operation by the other management user.

### BRIEF DESCRIPTION OF THE DRAWINGS

FIG. 1 illustrates an outline of a configuration of an entire system according to a first embodiment of the present invention;

FIG. 2 illustrates a hardware configuration example of each device in the first embodiment;

FIG. 3 illustrates an example of a program and data stored in a device-side memory 13-x in a device-side management computer 110-x;

FIG. 4 illustrates an example of a program and data stored in a memory 13-3 in a management computer 110-3;

FIG. 5 illustrates a configuration example of a device-side configuration management table 304-x;

FIG. 6 illustrates a configuration example of a device-side user management table 305-x;

FIG. 7 illustrates a configuration example of a resource group management table 306-x;

FIG. 8 illustrates a configuration example of a configuration management table 404;

FIG. 9 illustrates a configuration example of a user management table 405;

FIG. 10 illustrates a configuration example of a resource management table 406;

FIG. 11 illustrates an example of a flow of processing of registering information regarding a storage device as a self-management target in the management computer 110-3;

FIG. 12 illustrates an example of a flow of processing of registering information regarding a storage device as a managed management target in the management computer 110-3;

FIG. 13 illustrates an example of a flow of processing in which a managed management user uses the management computer 110-3 to operate a system resource operable by a self-management user;

FIG. 14 illustrates an example of a flow of processing in which the self-management user operates the system resource managed by the self-management user via a management computer 110-1;

FIG. 15 illustrates an example of a flow of processing in which the self-management user operates the system resource operable by the managed management user using the management computer 110-3; and

FIG. 16 illustrates an example of a flow of processing in which the managed management user operates the system resource managed by the managed management user via a management computer 110-2.

### DESCRIPTION OF THE PREFERRED EMBODIMENTS

In the following description, an “interface device” may be one or more interface devices. The one or more interface devices may be at least one of the following interface devices.
One or more input and output (I/O) interface devices. The input and output (I/O) interface device is an interface device for at least one of an I/O device and a remote computer for display. The I/O interface device for the computer for display may be a communication interface device. The at least one I/O device may be either a user interface device, for example, an input device such as a keyboard and a pointing device, or an output device such as a display device.
One or more communication interface devices. The one or more communication interface devices may be one or more communication interface devices of the same type (for example, one or more network interface cards (NIC)), or may be two or more communication interface devices of different types (for example, an NIC and a host bus adapter (HBA)).

Further, in the following description, a “memory” is one or more memory devices which are an example of one or more memory devices, and may be typically a main storage device. At least one memory device of the memory may be a volatile memory device, or may be a non-volatile memory device.

Further, in the following description, a “persistent memory device” may be one or more persistent memory devices which are an example of one or more memory devices. The persistent memory device is typically a nonvolatile memory device (for example, auxiliary memory device), specifically, for example, a hard disk drive (HDD), a solid state drive (SSD), a Non-Volatile Memory Express (NVME) drive, or a storage class memory (SCM).

Further, in the following description, the “memory device” may be at least the memory of the memory and the persistent memory device.

Further, in the following description, a “processor” may be one or more processor devices. At least one processor device is typically a microprocessor device such as a central processing unit (CPU), but may be another type of processor device such as a graphics processing unit (GPU). At least one processor device may be a single-core processor device, or may be a multi-core processor device. At least one processor device may be a processor core. At least one processor device may be a processor device in a broad sense such as a circuit (for example, a field-programmable gate array (FPGA), a complex programmable logic device (CPLD), or an application specific integrated circuit (ASIC)) that is an aggregate of gate arrays by a hardware description language that performs part or all of processing.

Further, in the following description, although information that can be output for input may be described by an expression such as an “xxx table”, the information may be data of any structure (for example, may be structured data or unstructured data), may be a neural network that generates an output for an input, or may be a learning model represented by a genetic algorithm or a random forest. Accordingly, the “xxx table” can be referred to as “xxx information”. Further, in the following description, a configuration of each table is an example, and one table may be divided into two or more tables, or all or a part of two or more tables may be one table.

Further, although processing performed with a “program” as a subject may be described, the program is executed by a processor, and thus, predetermined processing is appropriately performed by using the memory device and/or the interface device. Accordingly, the subject of the processing may be the processor (or a device or a system having the processor). The program may be installed on an apparatus such as a computer from a program source. The program source may be, for example, a program distribution server or a computer-readable recording medium (for example, a non-transitory recording medium). Further, in the following description, two or more programs may be realized as one program, or one program may be realized as two or more programs.

Further, in the following description, an ID is adopted as an example of identification information of an element, but the identification information may be any information that can identify the element, such as a name.

Further, in the following description, a common reference sign of reference signs will be used when the same kind of elements are described without distinguishing these elements, and reference signs may be used when the same kind of elements are distinguished. For example, in a case where a plurality of management computers are not distinguished, the management computers are described as a “management computer 110”, and in a case where each management computer is distinguished, the management computers are described as a “management computer 110-1”, a “management computer 110-2”, and a “management computer 110-3”.

Hereinafter, several embodiments of the present invention will be described with reference to the drawings. Note that, in the following description, a logical volume is referred to as “Vol”.

### First Embodiment

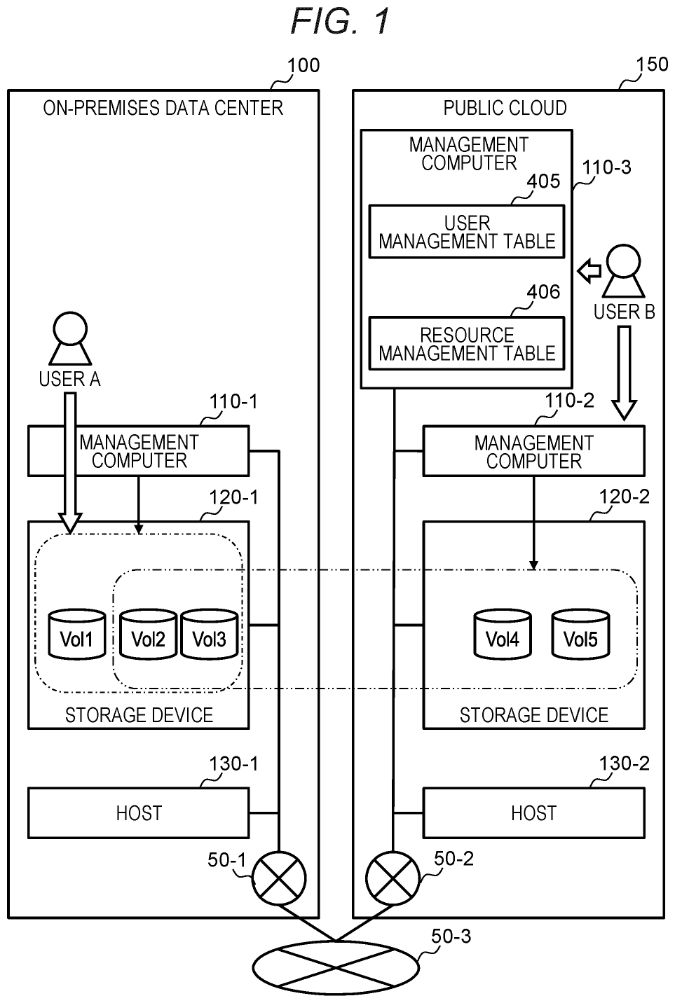

FIG. 1 illustrates an outline of a configuration of an entire system according to a first embodiment of the present invention.

There are an on-premises data center 100 and a public cloud 150. A network 50-1 (for example, a local area network (LAN)) in the on-premises data center 100 and a network 50-2 (for example, a LAN) in the public cloud 150 are connected to a network 50-3 (for example, the Internet). Communication between the on-premises data center 100 and the public cloud 150 can be performed via the networks 50-1, 50-3, and 50-2.

The on-premises data center 100 includes a management computer 110-1, a storage device 120-1, and a host 130-1. These devices 110-1, 120-1, and 130-1 can communicate via the network 50-1. The storage device 120-1 includes Vol 1 and Vol 2. The host 130-1 may issue an I/O request designating Vol (for example, Vol 1) provided by the storage device 120-1, and the storage device 120-1 may perform I/O of data with respect to Vol designated by the I/O request in response to the I/O request.

The public cloud 150 includes management computers 110-2 and 110-3, a storage device 120-2, and a host 130-2. These devices 110-2, 110-3, 120-2 and 130-2 can communicate via the network 50-2. The host 130-2 may issue an I/O request designating Vol provided by the storage device 120-2, and the storage device 120-2 may perform I/O of data with respect to Vol designated by the I/O request in response to the i/O request.

A storage system includes storage devices 120-1 and 120-2. Self service and managed services are mixed as management services of the storage system. Hereinafter, the storage device 120-1 of the on-premises data center 100 is referred to as an “on-premises storage device 120-1”, and the storage device 120-2 of the public cloud 150 is referred to as a “public cloud storage device 120-2”.

A dashed dotted line frame means a self-range. The self-range is one or more system resources that can be operated in self-management. The self-range is closed in the on-premises storage device 120-1 and includes only system resources in the storage device 120-1. A user A can operate the system resources in the self-range by using the management computer 110-1. The user A is a self-management user, and may be, for example, an employee of a purchaser (for example, a company) or a user of the storage device 120-1.

A dashed double-dotted line frame means a managed range. The managed range is one or more system resources that can be operated in managed management. The managed range includes system resources in the public cloud storage device 120-2 and system resources in the on-premises storage device 120-1. A user B can operate the system resources in the managed range by using the management computer 110-2. The user B is a managed management user, and may be, for example, an employee of a vendor of the storage device 120-1 and/or 120-2.

For example, in the on-premises storage device 120-1, there is Vol 2 as a backup destination of Vol 1 to which data is written from the host 130-1. The user B sets a disaster recovery configuration between Vol 2 in the on-premises storage device 120-1 and Vol 4 in the public cloud storage device 120-2 by the managed service. Specifically, the following operation environment is constructed.
The user B forms a Vol pair of Vol 2 and Vol 3 in the on-premises storage device 120-1. Consequently, copy from Vol 2 (primary Vol) to Vol 3 (secondary Vol) is performed.
Vol 3 is a virtual Vol of Vol 4 in the public cloud storage device 120-2. Thus, data of which a copy destination is Vol 3 is written to Vol 4. As a result, data written in Vol 2 is copied to Vol 4. Note that, the user B may perform setting for generating Vol 5 as a snapshot of Vol 4 in the managed service.

According to such an operation environment, there is an overlapping range between the self-range and the managed range. According to the example illustrated in FIG. 1, Vol 2 and Vol 3 are system resources included in the overlapping range. When the user A operates the system resources (for example, a Vol pair of Vol 2 and Vol 3) in the overlapping range, there is a concern that an intended environment of the user B is broken.

Therefore, in the present embodiment, the following configuration is adopted.

That is, the management computer 110-3 capable of managing both the on-premises storage device 120-1 and the public cloud storage device 120-2 is prepared. The management computer 110-3 retains a user management table 405 and a resource management table 406. The user management table 405 represents whether a type of the management user is the self-management user or the managed management user for each management user. The resource management table 406 represents which management user manages each system resource to perform the managed management.

The management computer 110-3 specifies that an operation content and an operation target resource are designated by the user B and that the operation target resource is the system resource managed by the user A from the user management table 405 and the resource management table 406, and in a case where the management computer 110-3 specifies that a managed operation regarding the operation target resource influences the self-management, an operation authority of the user A is changed and then an operation according to the operation content is performed on the operation target resource.

Hereinafter, the present embodiment will be described in detail.

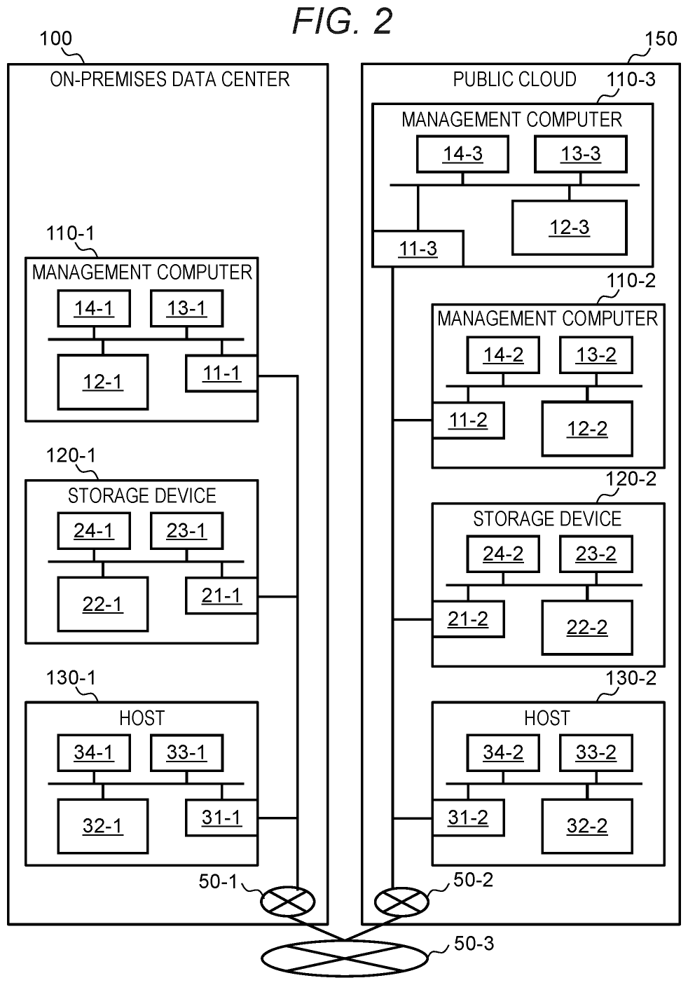

FIG. 2 illustrates a hardware configuration example of each device in the present embodiment.

The management computer 110 includes an interface device 11, a persistent memory device 12, a memory 13, and a processor 14 connected thereto.

The storage device 120 includes an interface device 21, a persistent memory device 22, a memory 23, and a processor 24 connected thereto.

The host 130 includes an interface device 31, a persistent memory device 32, a memory 33, and a processor 34 connected thereto.

In the present embodiment, at least one of the following contents may be adopted.
An I/O network between the host 130 and the storage device 120 and a management network between the management computer 110 and the storage device 120 may be different.
The at least one network 50 may be redundant. The at least one network 50 may be any of Ethernet (registered trademark), Fibre Channel, and radio.
The management computer 110 may be included in the storage device 120.
The management computer 110-3 may be present outside of the public cloud 150. For example, the management computer 110-3 may be present in the on-premises data center 100.
The management computer 110-2 may be included in the management computer 110-3.
A function as the host 130-1 may be included in the storage device 120-1. A function as the host 130-2 may be included in the storage device 120-2.
Each of the devices 110-1, 110-2, 110-3, 120-1, 120-2, 130-1, 130-2, and 130-3 is a physical device in the present embodiment, but at least one of these devices may be a logical device based on a plurality of types of calculation resources.
At least one of the management computers 110-1 to 110-3 may function as a server, and the management user may input information to the management computer 110 by using a client computer (for example, an information processing terminal).
A plurality of hosts 130-1 may be provided, or a plurality of on-premises storage devices 120-1 may be provided. Similarly, a plurality of hosts 130-2 may be provided, or a plurality of public cloud storage devices 120-2 may be provided.
In the on-premises data center 100, one or more management users including the user A may exist as the management user who uses the management computer 110-1 (for example, the management computer 110-1 may be a server, and one or more clients of the management computer 110-1 may exist).
In the public cloud 150, one or more management users including the user B may exist as the management user who uses the management computer 110-2 (for example, the management computer 110-2 may be a server, and one or more clients of the management computer 110-2 may exist).

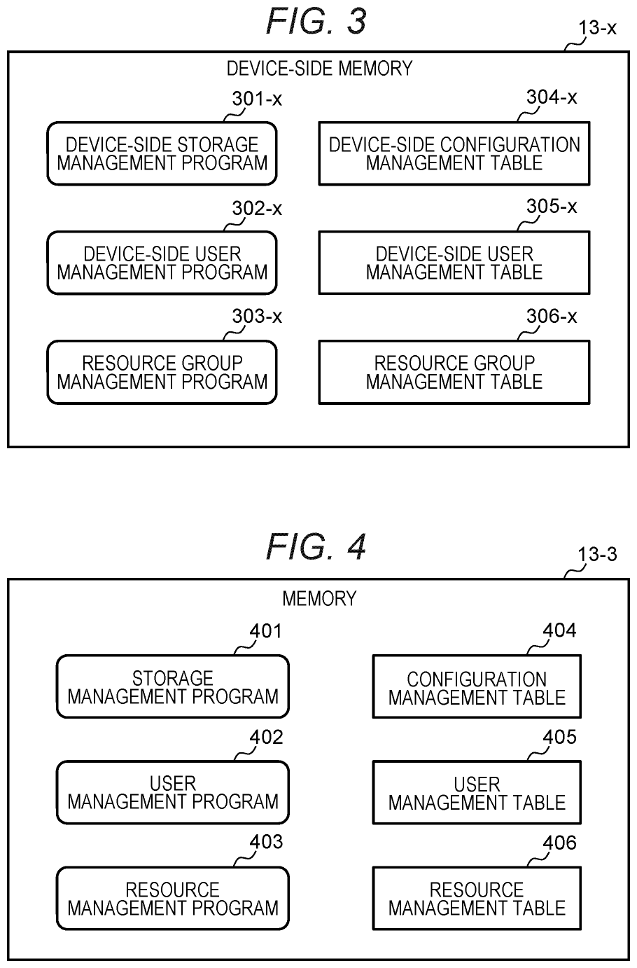

FIG. 3 illustrates an example of a program and data stored in a device-side memory 13-x in a device-side management computer 110-x. Note that, a value of x is “1” or “2”. That is, the memory 13-x illustrated in FIG. 3 is a memory 13-1 in the management computer 110-1 and a memory 13-2 in the management computer 110-2. Thus, the “device-side” means a management computer other than the management computer 110-3.

The memory 13-x stores a device-side storage management program 301-x, a device-side user management program 302-x, a resource group management program 303-x, a device-side configuration management table 304-x, a device-side user management table 305-x, and a resource group management table 306-x. The programs 301-x to 303-x are executed by a processor 14-x (x=1 or 2).

The device-side storage management program 301-x is a program that receives a request from a higher-order program (for example, a program communicating with the client computer of the management user), executes a configuration change of the storage device 120, and returns configuration information of the storage device 120 to the higher-order program.

The device-side user management program 302-x is a program for managing a management user and a group of management users of the storage device 120.

The resource group management program 303-x is a program that manages a group of system resources constituting the storage device 120 and which user group can manage the group with which authority.

The device-side configuration management table 304-x is a table that retains information regarding the configuration of the storage device 120, and is referred to or updated by the device-side storage management program 301-x.

The device-side user management table 305-x is a table that retains information regarding a management user and a user group of the storage device 120, and is referred to or updated by the device-side user management program 302-x.

The resource group management table 306-x is a table that holds a group of system resources constituting the storage device 120 and information indicating which user group can manage the group with which authority, and is referred to or updated by the resource group management program 303-x.

FIG. 4 illustrates an example of a program and data stored in a memory 13-3 in the management computer 110-3.

The memory 13-3 stores a storage management program 401, a user management program 402, a resource management program 403, a configuration management table 404, a user management table 405, and a resource management table 406. The programs 401 to 403 are executed by a processor 14-3.

The storage management program 401 is a program for registering information regarding the storage device 120 as a management target, collecting information regarding the storage device 120 as the management target, and managing the configuration of the storage device 120 as the management target.

The user management program 402 is a program for managing a management user and a user group.

The resource management program 403 is a program for managing system resources of the storage device 120 as the management target.

The configuration management table 404 is a table that retains information regarding the configuration of the storage device 120 as the management target, and is referred to or updated by the storage management program 401.

The user management table 405 is a table that retains information regarding the management user and the user group, and is referred to or updated by the user management program 402.

The resource management table 406 is a table that retains information regarding the system resources of the storage device 120 as the management target, and is referred to or updated by the resource management program 403.

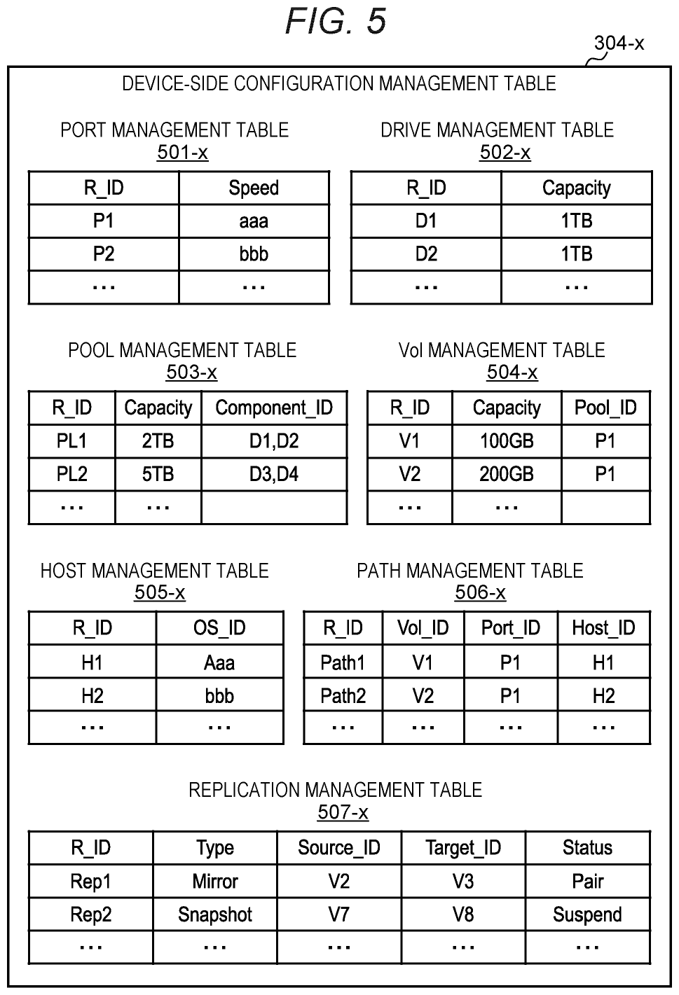

FIG. 5 illustrates a configuration example of the device-side configuration management table 304-x.

The device-side configuration management table 304-x retains information regarding the system resources of the storage device 120 and the configuration thereof (association of each system resource). For example, the system resources of the storage device 120 may include a port, a pool, Vol, and a path. The type of the system resource may be different depending on whether the system resource is the on-premises storage device 120-1 or the public cloud storage device 120-2.

For example, the device-side configuration management table 304-x includes a port management table 501-x, a drive management table 502-x, a pool management table 503-x, a Vol management table 504-x, a host management table 505-x, a path management table 506-x, and a replication management table 507-x.

The port management table 501-x has an entry for each port. The entry retains information indicating R_ID (resource ID (here, port ID)) and Speed (transfer speed of the port). The “port” is an element of an interface device 21-x.

The drive management table 502-x has an entry for each drive. The entry retains information indicating R_ID (resource ID (here, drive ID)) and Capacity (capacity of drive). The “drive” is an example of a persistent memory device in a persistent memory device 22-x.

The pool management table 503-x has an entry for each pool. The entry retains information indicating R_ID (resource ID (here, pool ID)), Capacity (capacity of the pool), and Component_ID (list of IDs of drives on which the pool is based). The “pool” is a logical memory resource associated with Vol or from which Vol is cut out.

The Vol management table 504-x has an entry for each Vol. The entry retains information indicating R_ID (resource ID (here, an ID of the Vol)), Capacity (the capacity of the Vol), and Pool_ID (an ID of the pool with which Vol is associated or from which Vol is cut out).

The host management table 505-x has an entry for each host 130-x. The entry retains information indicating R_ID (resource ID (here, host ID)) and OS_ID (ID of an operating system (OS) in the host 130-x).

The path management table 506-x has an entry for each path. The entry retains information indicating Vol_ID (an ID of Vol to which the path is connected), Port ID (an ID of the port through which the path passes), and Host_ID (an ID of the host 130-x using the path).

The replication management table 507-x has an entry for each Vol pair. The entry retains information indicating R_ID (resource ID (here, an ID of the Vol pair)), Type (a type of the Vol pair), Source_ID (an ID of the primary Vol), Target_ID (an ID of the secondary Vol), and Status (a status of the Vol pair). Status “Pair” means that when the primary Vol is updated, the secondary Vol is updated, and the primary Vol and the secondary Vol are maintained in the same content. Status “Suspend” means that the secondary Vol is not updated even though the primary Vol is updated, and a difference between the primary Vol and the secondary Vol is managed.

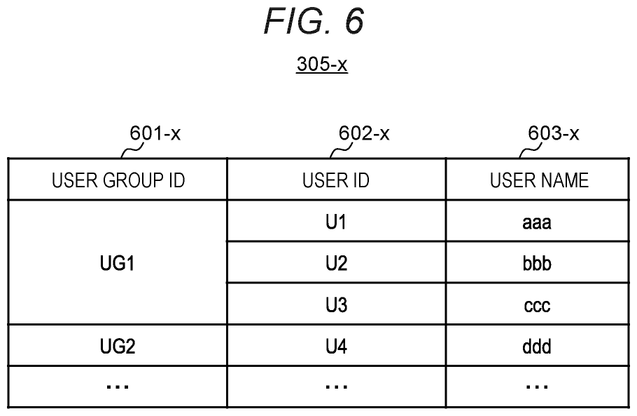

FIG. 6 illustrates a configuration example of the device-side user management table 305-x.

The device-side user management table 305-x has an entry for each management user. The entry retains information such as a user group ID 601-x, a user ID 602-x, and a user name 603-x.

The user group ID 601-x represents an ID of a user group to which the management user belongs. The user ID 602-x represents an ID of the management user. The user name 603-x represents a name of the management user. The user group includes one or more management users.

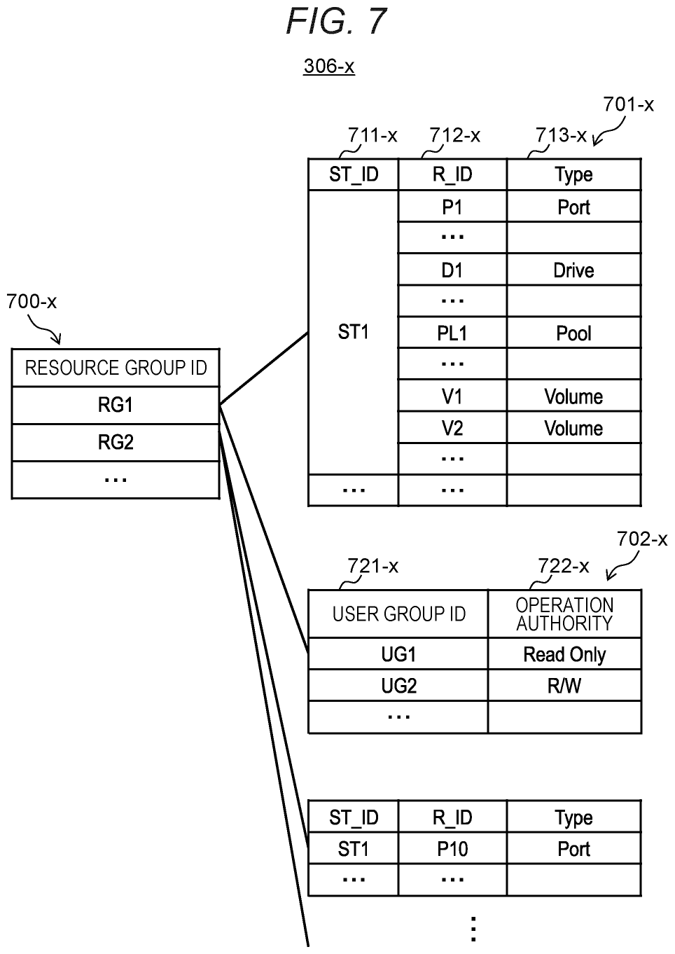

FIG. 7 illustrates a configuration example of the resource group management table 306-x.

The resource group management table 306-x represents a relationship among a resource group, a resource, a user group, and an operation authority. For example, the resource group management table 306-x includes one resource group list 700-x, one or more resource lists 701-x, and one or more user group lists 702-x.

The resource group list 700-x has an entry for each resource group, and the entry represents an ID of the resource group. One resource list 701-x and one user group list 702-x are associated with one entry.

The resource list 701-x has an entry for each system resource. The entry retains information such as ST_ID 711-x, R_ID 712-x, and Type 713-x. ST_ID 711-x represents an ID of a storage device 120-x having system resources. R_ID 712-x represents an ID of the system resource. Type 713-x represents a type of the system resource.

The user group list 702-x has an entry for each user group. The entry retains information such as a user group ID 721-x and an operation authority 722-x. The user group ID 721-x represents an ID of the user group.

The operation authority 722-x represents an operation authority (a type of a possible operation). The “operation authority” may be an authority to change the setting for the system resource. A value of the operation authority 722-x may include, for example, “R/W” meaning that the setting can be changed or referred to, “Read Only” meaning that the setting cannot be changed but the setting can be referred to, and “Write Only” meaning that the setting cannot be referred to but the setting can be changed.

According to the example illustrated in FIG. 7, at least one of the following contents may be adopted.
It is possible to classify a plurality of different system resources having different resource types into one resource group.
One system resource can belong to a plurality of different resource groups (however, a combination that does not cause inconsistency in a relationship among the system resource, the user group, and the operation authority is set).
A relationship between the resource group and the user group is N:M (both N and M are natural numbers, and N=M or N≠M), and different operation authorities can be set to each user group belonging to one resource group. One user group may be associated with a plurality of different resource groups.
The operation authority may include an authority of a detailed operation that means permission of only a specific operation within a range of the resource group (example: permission of only a copy operation, and only operation information of the resource can be acquired) in addition to a basic authority such as “Read Only”, “R/W”, and “Write Only”.
The operation authority may be set on a system resource basis instead of on a resource group basis.
The operation authority may be set on a management user basis instead of on a user group basis.

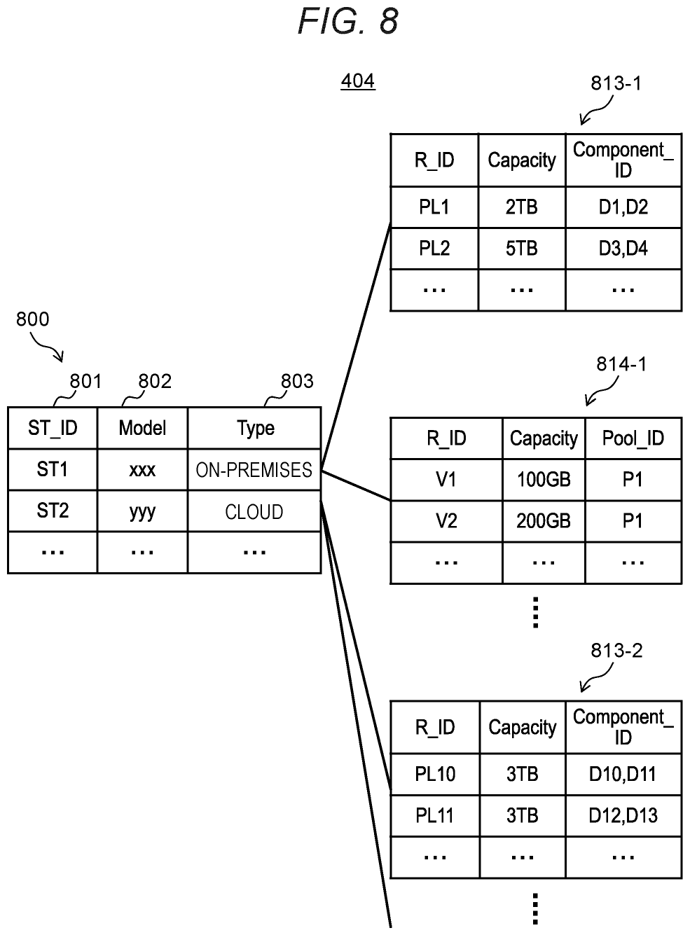

FIG. 8 illustrates a configuration example of the configuration management table 404.

The configuration management table 404 retains at least a part of information included in the device-side configuration management table 304 of each storage device 120 for each storage device 120.

For example, the configuration management table 404 includes one storage device list 800. The storage device list 800 has an entry for each storage device 120. The entry retains information such as ST_ID 801, Model 802, and Type 803. ST_ID 801 represents an ID of the storage device 120. Model 802 represents a model of the storage device 120. Type 803 indicates whether the storage device 120 is the on-premises device or the cloud device.

For each storage device 120 (for each entry in the storage device list 800), at least a part of the information included in the device-side configuration management table 304 of the storage device 120 (for example, at least a part of the tables 501 to 507 illustrated in FIG. 5), for example, the pool management table 813, the Vol management table 814, and the like are associated.

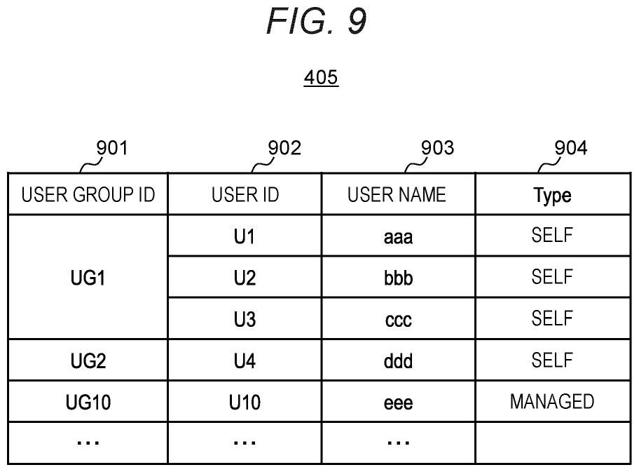

FIG. 9 illustrates a configuration example of the user management table 405.

The user management table 405 has an entry for each management user. The entry retains information such as a user group ID 901, a user ID 902, a user name 903, and Type 904. The pieces of information 901 to 903 are the same as the pieces of information 601 to 603 illustrated in FIG. 6. Type indicates whether the management user is the self-management user or the managed management user.

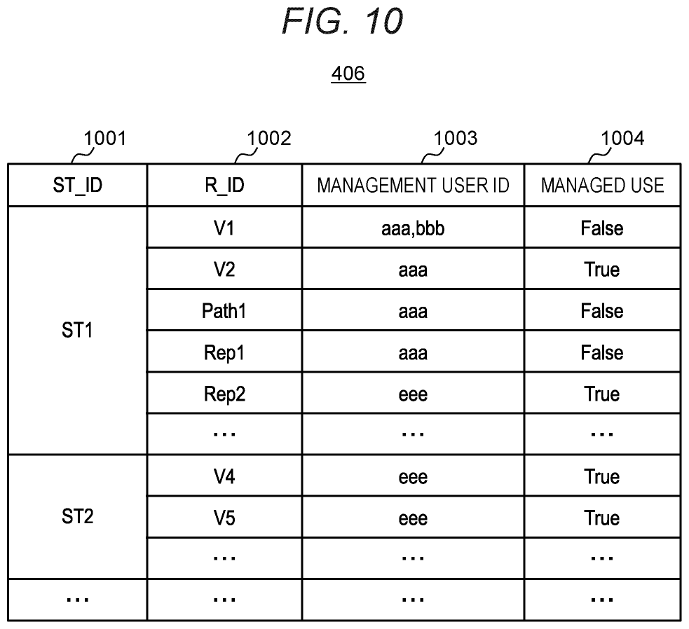

FIG. 10 illustrates a configuration example of the resource management table 406.

The resource management table 406 indicates a management user who creates (manages) a system resource for each system resource as the management target and whether or not the system resource is used in the managed service. The resource management table 406 has, for example, an entry for each resource. The entry retains information such as ST_ID 1001, R_ID 1002, a management user ID 1003, and managed use 1004.

ST_ID 1001 represents an ID of the storage device 120 having system resources. R_ID 1002 represents an ID of the system resource. The management user ID 1003 represents an ID of the management user who creates (manages) the system resource. The managed use 1004 indicates whether or not the system resource is used in the managed service. “True” means use in the managed service, and “False” means that the service is not used in the managed service.

One system resource can belong to a plurality of different resource groups, and IDs of one or more management users associated with the plurality of resource groups are associated with the one system resource (See, for example, first entry).

Hereinafter, an example of processing performed in the present embodiment will be described.

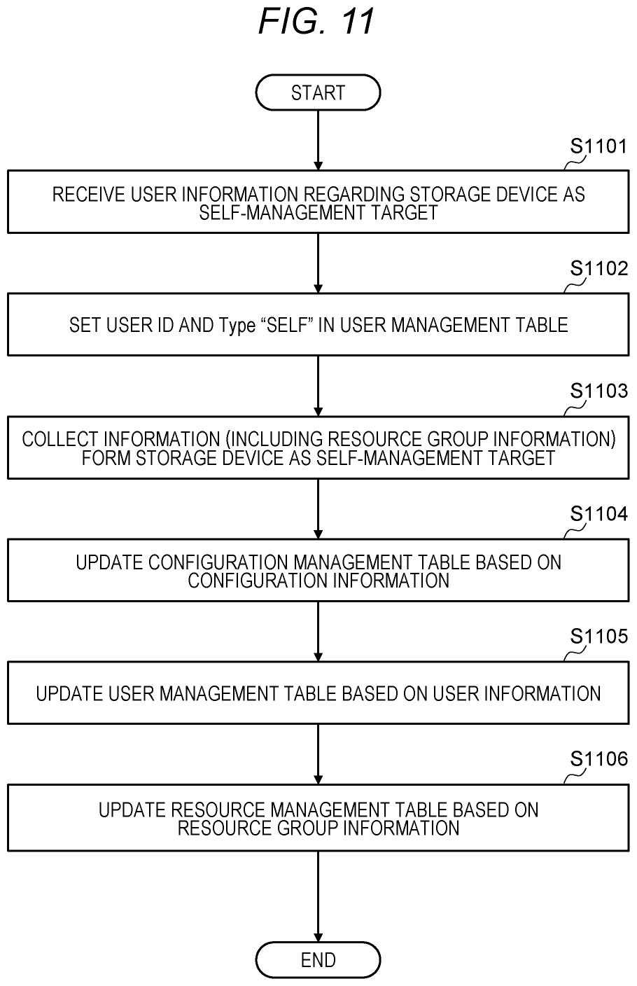

FIG. 11 illustrates an example of a flow of processing of registering information regarding the storage device as a self-management target in the management computer 110-3.

The user management program 402 receives user information regarding the storage device as the self-management target from the user B (see FIG. 1) or from the higher-order program via a user interface (UI) (S1101). Information indicating which storage device is the “storage device as the self-management target” (for example, ST_ID) may be received together with the user information. Further, the user information is, for example, information including information of the user A (see FIG. 1).

The user management program 402 sets a user group ID 901, a user ID 902, a user name 903, and Type 904 “self” in the user management table 405 based on the user information (S1102). For example, information regarding the user A is set.

The storage management program 401 collects information from the storage device as the self-management target (S1103). The collected information may include configuration information (for example, information registered in the device-side configuration management table 304), user information (for example, information registered in the device-side user management table 305), and resource group information (for example, information registered in the resource group management table 306).

The storage management program 401 updates the configuration management table 404 based on the collected configuration information (S1104). For example, in a case where the storage device as the self-management target is the on-premises storage device 120-1, the storage management program 401 registers ST_ID 801, Model 802, and Type 803 “on-premises” of the on-premises storage device 120-1 in the storage device list 800, and associates various kinds of information in the configuration information with the entries having these pieces of information 801 to 803.

Further, the user management program 402 updates the user management table 405 based on the collected user information (S1105). For example, in a case where a user C (an example of a user different from the user A) is specified for the same user group as the user group to which the user A to which the information is set in S1102 belongs, the user management program 402 sets the user ID 902, the user name 903, and Type 904 “self” of the user C in the user management table 405 for the user group ID 901 to which the user A belongs.

The resource management program 403 updates the resource management table 406 based on the collected resource group information (S1106). For example, the following processing is performed.
For an existing resource (system resource registered in the resource management table 406) among the system resources indicated by the resource group information, the resource management program 403 adds the same user ID as the user ID set in S1102 and the user ID of the user in the user group associated with the resource group to which the existing resource belongs to the management user ID 1003 of the existing resource, and sets the managed use 1004 of the existing resource to “False”.
For a new resource (system resource not registered in the resource management table 406) among the system resources indicated by the resource group information, the resource management program 403 adds the user ID set in S1102 to the management user ID 1003 of the new resource, and sets the managed use 1004 of the new resource to “False”.

After the processing illustrated in FIG. 11, in a case where the configuration of the storage device as the self-management target is changed by the self-management user (that is, in a case where the information in the storage device is changed after the information is collected from the storage device as the self-management target), the changed information is reflected in the tables 404 to 406 in the management computer 110-3. For example, in a case where the information in the storage device 120-1 as the self-management target is changed by the user A, the device-side storage management program 301-1 may notify the management computer 110-3 of the configuration change content, or the latest information of the storage device 120-1 may be acquired by the management computer 110-3 by a method of periodically transmitting an inquiry to the device-side storage management program 301-1 by the storage management program 401, and the tables 404 to 406 may be maintained as the latest information based on the information.

Further, in the processing illustrated in FIG. 11, the information included in the tables 304 to 306 may be collected from the management computer 110-1 instead of or in addition to collecting the information from the storage device as the self-management target.

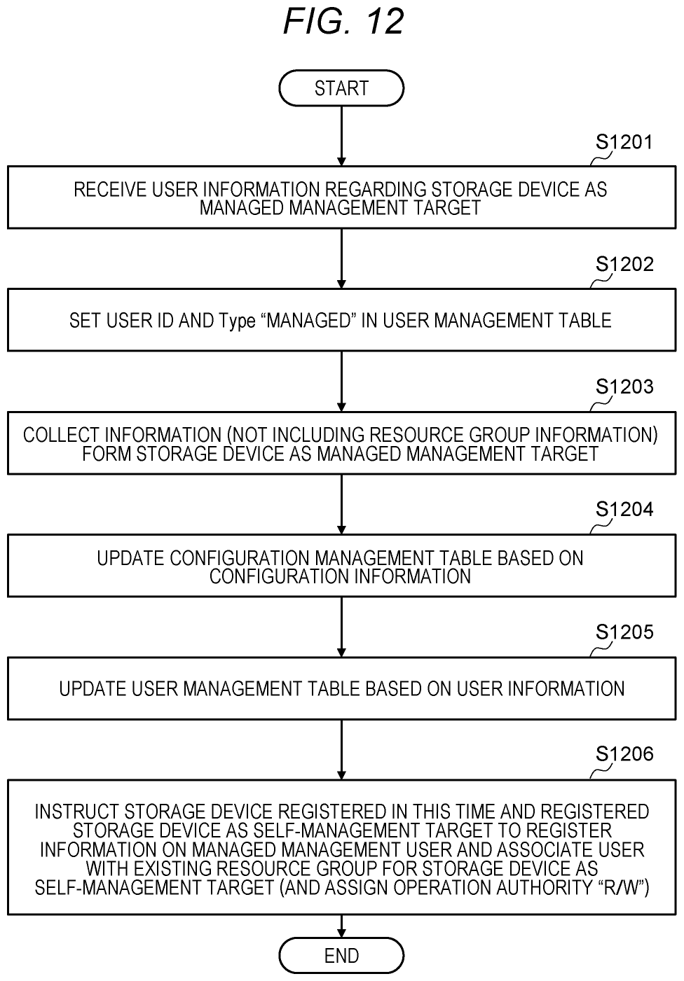

FIG. 12 illustrates an example of a flow of processing of registering the information regarding the storage device as a managed management target in the management computer 110-3.

The user management program 402 receives user information regarding the storage device as the managed management target from the user B (see FIG. 1) or from the higher-order program via the UI (S1201). Information indicating which storage device is the “storage device as the managed management target” (for example, ST_ID) may be received together with the user information. Further, the user information is, for example, information including information of the user B (see FIG. 1).

The user management program 402 sets a user group ID 901, a user ID 902, a user name 903, and Type 904 “managed” in the user management table 405 based on the user information (S1202). For example, information regarding the user B is set.

The storage management program 401 collects information from the storage device as the managed management target (S1203). The collected information may include configuration information (for example, information registered in the device-side configuration management table 304) and user information (for example, information registered in the device-side user management table 305), and may not include resource group information.

The storage management program 401 updates the configuration management table 404 based on the collected configuration information (S1204). For example, in a case where the storage device as the managed management target is the public cloud storage device 120-2, the storage management program 401 registers ST_ID 801, Model 802, and Type 803 “cloud” of the public cloud storage device 120-2 in the storage device list 800, and associates various kinds of information in the configuration information with the entries having these pieces of information 801 to 803.

Further, the user management program 402 updates the user management table 405 based on the collected user information (S1205). For example, in a case where a user D (an example of a user different from the user B) is specified for the same user group as the user group to which the user B to which the information is set in S1202 belongs, the user management program 402 sets a user ID 902, a user name 903, and Type 904 “managed” of the user D in the user management table 405 with respect to the user group ID 901 to which the user B belongs.

In response to an instruction from the higher-order program or the user B, the resource management program 403 transmits an instruction designating the following to the managed management target storage device registered this time and the storage device as the registered self-management target (S1206).
Information associated with the user whose Type 904 “managed” is set in S1202 or S1205 is registered in the storage device of a transmission destination of the instruction.
A user whose Type 904 “managed” is set in S1202 or S1205 is associated with an existing resource group in the registered storage device as the self-management target (for example, the user group including the user is associated with the resource group) and “R/W” is set as the operation authority corresponding to the user group of the user.

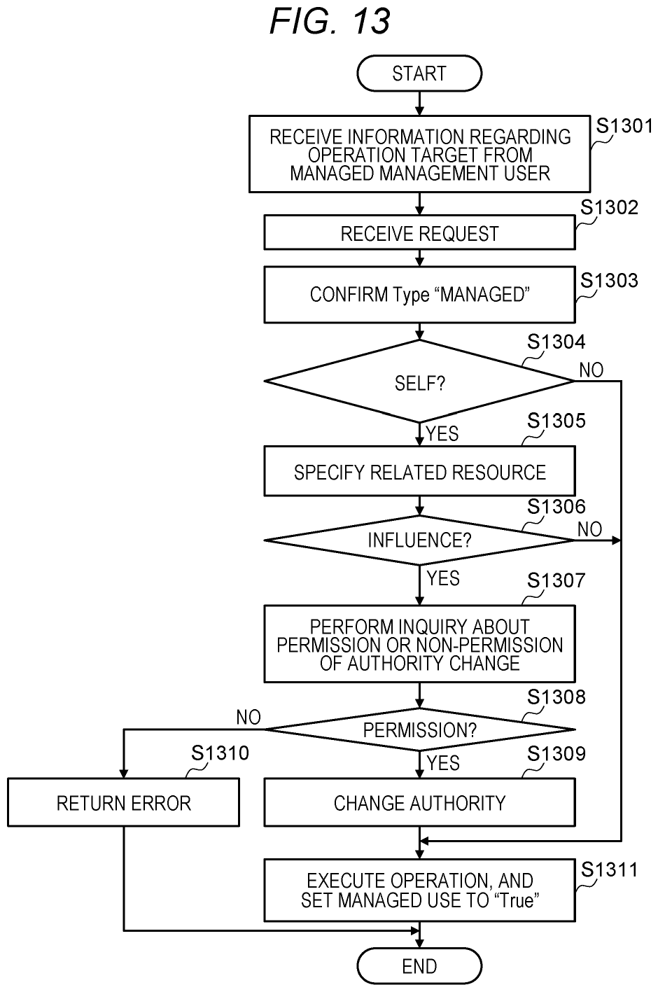

As described above, according to the processing illustrated in FIG. 12, setting is made such that the managed management user can operate the system resources in the storage device as the self-management target. This setting may be performed at the end of the processing illustrated in FIG. 12 or at the beginning of the processing illustrated in FIG. 13.

FIG. 13 illustrates an example of a flow of processing in which the managed management user uses the management computer 110-3 to operate the system resources operable by the self-management user.

The storage management program 401 receives information regarding an operation target from the managed management user via the UI (S1301). The information includes, for example, information indicating the operation content and information indicating the operation target resource. An example of the “operation content” is the construction of a disaster recovery configuration between the on-premises data center 100 and the public cloud 150. An example of the “operation target resource” is Vol 2 (an example of the system resource operable by the self-management user) in the on-premises storage device 120-1 as a source Vol, and is Vol 5 in the public cloud storage device 120-2 as a target Vol.

The storage management program 401 receives a request for an operation according to the information received in S1301 from, for example, the managed management user via the UI (S1302). The user ID is associated with the request. The storage management program 401 specifies that Type 904 of a request user (the user who issues the request) is “managed” from the user management table 405 by using the user ID associated with the request as a key (S1303).

It is determined whether or not the managed use 1004 of the operation target resource is “False” (and/or whether or not Type 904 is “self”) (S1304). Specifically, one or both of the following contents are performed.
The resource management program 403 specifies the managed use 1004 of the operation target resource while referring to the resource management table 406. The storage management program 401 determines whether or not the specified managed use 1004 is “False”.
The resource management program 403 specifies the management user of the operation target resource while referring to the resource management table 406. The user management program 402 specifies Type 904 of the specified management user while referring to the user management table 405. The storage management program 401 determines whether or not the specified Type 904 is “self”.

In a case where the determination result in S1304 is false (S1304: No), the storage management program 401 executes the operation designated by the request, and sets the managed use 1004 of the operation target resource to “True” (S1311). The “system resource regarding the operation” in the case of S1304: No may include the operation target resource designated by the request and the related resource of the operation target resource. The related resource may be a system resource (a system resource directly or indirectly associated with the operation target resource) included in a range determined with the operation target resource as a reference, in other words, a system resource associated with the operation target resource to satisfy a predetermined condition. An example of the “predetermined condition” may be that the operation target resource is associated with n or more system resources (n is an integer of 0 or more and a set value) across the n or more system resources. For example, in the example of FIG. 1, in a case where the operation target resources are Vol 2 and Vol 5, the related resources may include Vol 3 and Vol 4. Vol 3 constitutes a pair of Vol 2 and Vol (directly associated with Vol 2), and Vol 4 constitutes a pair of Vol 5 and Vol. Further, Vol 3 and Vol 4 are Vol (Vol through which data copied from Vol 2 to Vol 5 passes) in a range determined from a source Vol 2 and a target Vol 5. Further, in a case where a path through which a port passes is associated with Vol as the operation target resource, since the port and the path are also directly associated with the Vol, the port and the path may be related resources. The related resources may be specified from the configuration management table 404. Further, the “related resource” specified here may be a resource of which Type of the management user who creates (manages) the related resource is “self”.

In a case where the determination result in S1304 is true (S1304: Yes), the storage management program 401 specifies the related resource of the operation target resource from the configuration management table 404 (S1305). The storage management program 401 determines whether or not the managed operation (operation according to the designated operation content) regarding the operation target resource influences the self-management (S1306). For example, the determination in S1306 may include at least one of a determination A for each related resource and a determination B regardless of the presence or absence of the related resource. In a case where the result of any of the determinations is true, the determination result in S1306 may be true.

(Determination A) Determination as to whether or not the managed operation regarding the operation target resource (setting change in the managed management) is a factor of not satisfying a requirement of an existing operation environment constructed by the self-management user.

(Determination B) Determination as to whether or not the managed operation regarding the operation target resource (setting change in the managed management) causes a constraint that construction of an operation environment of a certain configuration cannot be performed on the storage device as the self-management target.

An example of the determination A may be as follows. That is, the operation regarding the operation target resource (setting change) is to increase a copy speed of the Vol pair including the operation target resource, and the determination A may be a determination as to whether or not such an operation can reduce a copy speed in the existing operation environment (environment constructed by the self-management user) including the related resource of the operation target resource to be less than a certain value. In a case where the result of the determination is true, it may be determined that the self-management is influenced.

An example of the determination B may be as follows. That is, the determination B may be whether or not the operation regarding the operation target resource (setting change) causes the number of components of the operation environment to reach a predetermined threshold value. For example, the operation regarding the operation target resource (setting change) is to increase the number of Vol pairs (replication pairs) of a predetermined Type in the storage device, and the determination B may be a determination as to whether or not the number of such Vol pairs reaches an upper limit in the storage device when such an operation is performed. In a case where the result of the determination is true, since it is not possible to construct the operation environment including newly constructing the Vol pair in the storage device, it may be determined that the self-management is influenced.

In a case where the determination result of S1306 is false (S1306: No), the storage management program 401 executes the operation designated by the request, and sets the managed use 1004 of the operation target resource to “True” (S1311).

In a case where the determination result in S1306 is true (S1306: Yes), an inquiry about permission or non-permission of the authority change is performed (S1307).

Specifically, S1307 includes the following contents.
In a case where the result of the determination A is true, the resource management program 403 specifies the management users of the influenced resources (related resources influenced by the managed operation regarding the operation target resource) while referring to the resource management table 406. The user management program 402 specifies the self-management users among the specified management users, specifies the user group including the specified self-management user, and specifies all the self-management users in the user group while referring to the user management table 405. The storage management program 401 inquires of the specified self-management user whether or not to permit to change the operation authority of the influenced resource (or the resource group including the influenced resource) and the operation target resource (or the resource group including the operation target resource) to “Read Only”.
In a case where the result of the determination B is true, the resource management program 403 inquires of the self-management user who manages the system resource in the on-premises storage device 120-1 that is the target of the self-management whether or not to permit to set the operation authority for the configuration that cannot be constructed in the construction of the new operation environment to “Read Only” (that is, “construction impossible” here). That is, in the resource group management table 306-x, the operation authority may be provided for a configuration including the resource in addition to the resource itself.

In a case where permission is replied from all the self-management users (S1308: Yes), the storage management program 401 causes the resource group management program 303-1 of the management computer 110-1 to change an operation authority 722-1 of the user group including the self-management user who replies the permission to “Read Only”, among the user group associated with the resource group including the influenced resource and the user group associated with the resource group including the operation target resource (S1309). Instead of or in addition to this processing, S1309 may include causing the management computer 110-1 to execute setting the operation authority of the configuration that cannot be constructed to “Read Only”. After S1309, the storage management program 401 performs S1311.

On the other hand, in a case where at least one self-management user replies non-permission (S1308: No), the storage management program 401 returns an error to the management user who inputs the information in S1301 (S1310).

Note that, instead of the determination based on a dynamic reply from the self-management user, S1307 may be a determination as confirmation as to whether or not the change of the operation authority is permitted in advance by a contract or the like. Further, in S1309, the storage management program 401 may cause the storage device 120 (for example, 120-1) having the influenced resource to change an access authority (or setting authority of a predetermined configuration) of the influenced resource to “Read Only”.

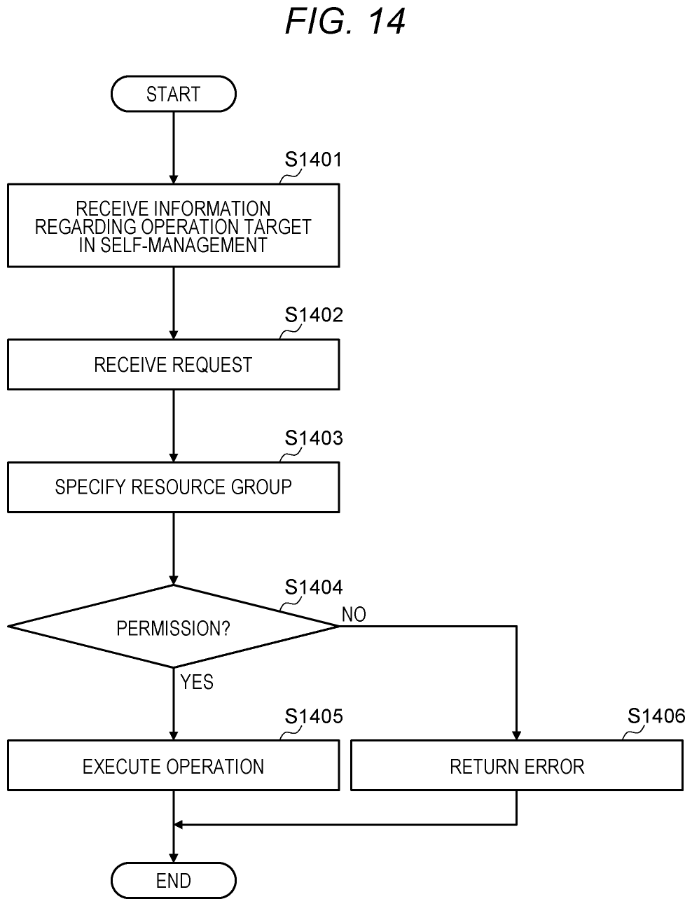

FIG. 14 illustrates an example of a flow of processing in which the self-management user operates the system resources managed by the self-management user via the management computer 110-1.

The device-side storage management program 301-1 receives the information regarding the operation target in the self-management from the user A (self-management user) via the UI (S1401). The information includes, for example, information indicating the operation content and information indicating the operation target resource.

The device-side storage management program 301-1 receives a request for an operation according to the information received in S1401 from, for example, the user A via the UI (S1402).

The resource group management program 303-1 specifies the resource group including the operation target resource indicated by the information received in S1401 while referring to the resource group management table 306-1 (S1403).

The resource group management program 303-1 determines whether or not the operation authority 722-1 of the user group including the user A who inputs the information in S1401 among the user group associated with the specified resource group is the authority to permit the operation content indicated by the information input in S1401 (S1404).

In a case where the determination result in S1404 is true (S1404: Yes), the device-side storage management program 301-1 executes the operation indicated by the information input in S1401 (S1405).

In a case where the determination result in S1404 is false (S1404: No), the device-side storage management program 301-1 returns an error to the user A who inputs the information in S1401 (S1406).

### Second Embodiment

A second embodiment will be described. At this time, differences from the first embodiment will be mainly described, and the description of common points with the first embodiment will be omitted or simplified.

The first embodiment is as follows.
(a) The user A is the self-management user, and the user B is the managed management user.
(b) The self-management and the managed management can be performed by using the management computer 110-3.
(c) The user A uses the management computer 110-1, and the user B uses the management computer 110-2 or 110-3.
(d) The system includes the on-premises data center 100 and the public cloud 150.

The second embodiment is different in (c) among (a) to (d). Specifically, in the second embodiment, the user A can use the management computer 110-3 in addition to the management computer 110-1. For example, the self-management user may perform at least one of (x) and (y) after grasping detailed settings of the storage device as the managed management target.
(x) The setting of the storage device managed by the self-management user is changed.
(y) The detailed setting of the storage device as the managed management target is changed.

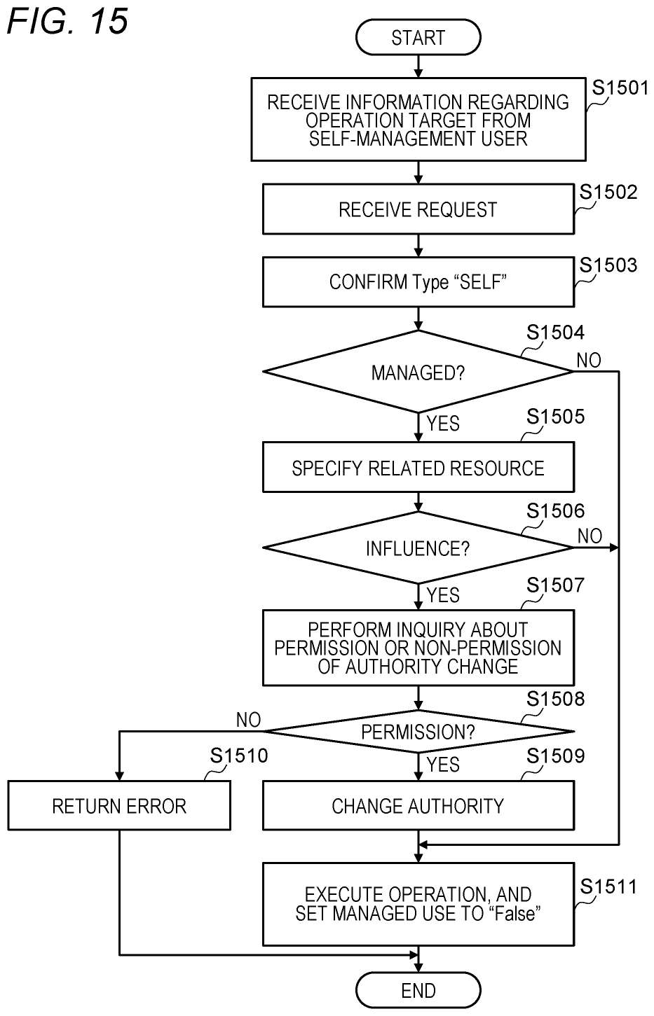

FIG. 15 illustrates an example of a flow of processing in which the self-management user uses the management computer 110-3 to operate the system resources operable by the managed management user.

The storage management program 401 receives the information regarding the operation target from the self-management user via the UI (S1501). The information includes, for example, information indicating the operation content and information indicating the operation target resource.

The storage management program 401 receives the request for the operation according to the information received in S1501 from, for example, the self-management user via the UI (S1502). The user ID is associated with the request. The storage management program 401 specifies that Type 904 of the request user (the user who issues the request) is “self” from the user management table 405 by using the user ID associated with the request as a key (S1503).

It is determined whether or not the managed use 1004 of the operation target resource is “True” (and/or whether or not Type 904 is “managed”) (S1504). Specifically, one or both of the following contents are performed.
The resource management program 403 specifies the managed use 1004 of the operation target resource while referring to the resource management table 406. The storage management program 401 determines whether or not the specified managed use 1004 is “True”.
The resource management program 403 specifies the management user of the operation target resource while referring to the resource management table 406. The user management program 402 specifies Type 904 of the specified management user while referring to the user management table 405. The storage management program 401 determines whether or not the specified Type 904 is “managed”.

In a case where the determination result in S1504 is false (S1504: No), the storage management program 401 executes the operation designated by the request, and sets the managed use 1004 of the operation target resource to “False” (S1511).

In a case where the determination result in S1504 is true (S1504: Yes), the storage management program 401 specifies the related resource of the operation target resource from the configuration management table 404 (S1505). The “related resource” specified here may be a resource of which Type of the management user who creates (manages) the related resource is “managed”.

The storage management program 401 determines whether or not a self-operation (operation according to the designated operation content) regarding the operation target resource influences the managed management (S1506). For example, the determination in S1506 may include at least one of a determination C for each related resource and a determination D regardless of the presence or absence of the related resource. In a case where the result of any of the determinations is true, the determination result in S1506 may be true.

(Determination C) Determination as to whether or not the self-operation regarding the operation target resource (setting change in the self-management) becomes the factor of not satisfying the requirement of the existing operation environment constructed by the managed management user.

(Determination D) Determination as to whether or not the self-operation regarding the operation target resource (setting change in self-management) causes the constraint that construction of the operation environment of the certain configuration cannot be performed on the storage device as the managed management target.

An example of the determination C may be as follows. That is, the operation regarding the operation target resource (setting change) is to increase the copy speed of the Vol pair including the operation target resource, and the determination C may be a determination as to whether or not such an operation can reduce the copy speed in the existing operation environment (environment constructed by the managed management user) including the related resource of the operation target resource to be less than a certain value. In a case where the result of the determination is true, it may be determined that the managed management is influenced.

An example of the determination D may be as follows. That is, the determination D may be whether or not the operation regarding the operation target resource (setting change) causes the number of components of the operation environment to reach a predetermined threshold value. In a case where the result of the determination is true, since the operation environment may not be constructed, it may be determined that the managed management is influenced.

In a case where the determination result in S1506 is false (S1506: No), the storage management program 401 executes the operation designated by the request, and sets the managed use 1004 of the operation target resource to “False” (S1511).

In a case where the determination result in S1506 is true (S1506: Yes), an inquiry about permission or non-permission of the authority change is performed (S1507). Specifically, S1507 includes the following contents.
In a case where the result of the determination C is true, the resource management program 403 specifies the management user of the influenced resource while referring to the resource management table 406. The user management program 402 specifies the managed management users among the specified management users, specifies the user group including the specified managed management users, and specifies all the managed management users among the user group while referring to the user management table 405. The storage management program 401 inquires of the specified managed management user whether or not to permit to change the operation authority of the influenced resource (or the resource group including the influenced resource) and the operation target resource (or the resource group including the operation target resource) to “Read Only”.
In a case where the result of the determination D is true, the resource management program 403 inquires of the managed management user who manages the system resource in the public cloud storage device 120-2 that is the target of the managed management whether or not to permit to set the operation authority for the configuration that cannot be constructed in the construction of the new operation environment to “Read Only” (that is, “construct impossible” here).

In a case where permission is replied from all the managed management users (S1508: Yes), the storage management program 401 causes the resource group management program 303-2 of the management computer 110-2 to change an operation authority 722-2 of the user group including the managed management user who replies the permission to “Read Only”, among the user group associated with the resource group including the influenced resource and the user group associated with the resource group including the operation target resource (S1509). Instead of or in addition to this processing, S1509 may include causing the management computer 110-2 to execute setting the operation authority of the configuration that cannot be constructed to “Read Only”. After S1509, the storage management program 401 performs S1511.

On the other hand, in a case where the non-permission is replied from at least one managed management user (S1508: No), the storage management program 401 returns an error to the management user who inputs the information in S1501 (S1510).

Note that, instead of the determination based on a dynamic reply from the managed management user, S1507 may be a determination as confirmation as to whether or not the change of the operation authority is permitted in advance by a contract or the like.

Further, in S1509, the storage management program 401 may cause the storage device 120 (for example, 120-2) having the influenced resource to change the access authority (or setting authority of a predetermined configuration) of the influenced resource to “Read Only”.

Similarly to the first embodiment, in the second embodiment, the managed management user can also operate the system resource in the overlapping range (system resource that can be operated by the self-management user) by using the management computer 110-3. In the second embodiment, there is a possibility that the self-management user operates the system resource that can be originally operated only by the managed management user. After the storage management program 401 causes the self-management user to confirm whether or not to change the setting of the system resource, the operation authority 722-1 of the user group associated with the resource group is changed to the management computer 110-1. Specifically, for example, the processing illustrated in FIG. 13 is also performed in the second embodiment. However, the operation target resource designated by the managed management user in S1301 is the system resource that can be operated by the managed management user, and may not include the system resource that can be operated by the self-management user. Further, in a case where the managed operation regarding the operation target resource influences the self-management (S1306: Yes), the inquiry performed for the self-management user in S1307 is an inquiry about permission or non-permission of authority change to an update authority (“Write Only” or “R/W”). In a case where permission is replied from all the self-management users (S1308: Yes), in S1309, the storage management program 401 causes the resource group management program 303-1 of the management computer 110-1 to change the operation authority 722-1 (or setting authority of a predetermined configuration) of the user group including the self-management user who replies the permission among the user group associated with the resource group including the influenced resource to the update authority (“Write Only” or “R/W”).

In the second embodiment, both the user A and the user B may operate the management computer 110-3. Whether Type 904 of the user is “self” or “managed”, and whether the managed use 1004 of the resource is “False” or “True” is checked. In a case where a relationship between a value of Type 904 and a value of the managed use 1004 is inconsistent (that is, in a case where Type 904 is “self” but the managed use 1004 is “True”, or Type 904 is “managed” but the managed use 1004 is “False”), the processing after S1305 of FIG. 13 or S1505 of FIG. 15 is performed.

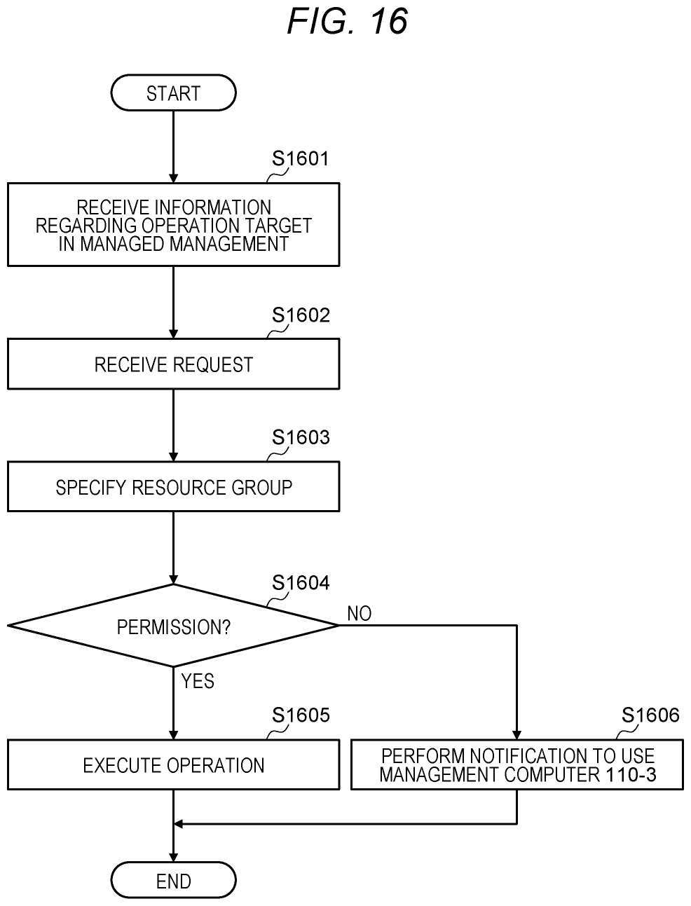

FIG. 16 illustrates an example of a flow of processing in which the managed management user operates the system resource managed by the managed management user via the management computer 110-2.

The device-side storage management program 301-2 receives the information regarding the operation target in the managed management from the user B (managed management user) via the UI (S1601). The information includes, for example, information indicating the operation content and information indicating the operation target resource.

The device-side storage management program 301-2 receives a request for an operation according to the information received in S1601 from, for example, the user B via the UI (S1602).

The resource group management program 303-2 specifies the resource group including the operation target resource indicated by the information received in S1601 while referring to the resource group management table 306-2 (S1603).

The resource group management program 303-2 determines whether or not the operation authority 722-2 of the user group including the user B who inputs the information in S1601 among the user group associated with the specified resource group is an authority to permit the operation content indicated by the information input in S1601 (S1604).

In a case where the determination result in S1604 is true (S1604: Yes), the device-side storage management program 301-2 executes the operation indicated by the information input in S1601 (S1605).

In a case where the determination result in S1604 is false (S1604: No), the device-side storage management program 301-2 notifies the user B who inputs the information in S1601 to use the management computer 110-3 (S1606).

Although several embodiments have been described above, these embodiments are merely examples for describing the present invention, and are not intended to limit the scope of the present invention to only these embodiments. The present invention can be implemented in other various forms.

For example, in at least one of the first and second embodiments, a private cloud may be adopted instead of the public cloud 150.

Further, for example, the management computer 110-2 according to the first embodiment may include the function of the management computer 110-3, and the management computer 110-1 according to the second embodiment may include the function of the management computer 110-3.

The above description can be summarized as follows, for example. The following summary may include description of modified examples of the above description and supplementary description.

The management computer 110-3 of the storage system is constructed. The management computer 110-3 includes an interface device 11-3, memory devices (for example, a persistent memory device 12-3 and a memory 13-3), and a processor 14-3 connected to the interface device 11-3 and the memory device. The storage system includes a first storage device (for example, the on-premises storage device 120-1) having a plurality of system resources and a second storage device (for example, the public cloud storage device 120-2) having a plurality of system resources.

The first storage device is the storage device as the target of the self-management. The self-management is storage management by the self-management user. The self-management user is a purchaser or a user of the first storage device or a person belonging to the purchaser or the user.

The second storage device is the storage device as the target of the managed management. The managed management is storage management by the managed management user. The managed management user is a vendor of the second storage device or a person belonging to the vendor.

The memory device stores user management information (for example, the user management table 405) and resource management information (for example, the resource management table 406). The user management information is information indicating whether the type of the management user is the self-management user or the managed management user for each management user. The resource management information is information indicating which management user manages and whether or not to perform the managed management for each system resource.

The processor 14-3 receives the designation of the operation content and the operation target resource from the management user of the first type. In a case where the processor specifies that the operation target resource is the system resource managed by the management user of the second type from the user management information and the resource management information (for example, S1304: Yes or S1504: Yes), specifies that the operation according to the operation content for the operation target resource influences the storage management by the management user of the second type (for example, S1306: Yes or S1506: Yes), and specifies that there is the authority change permission from the management user of the second type (for example, S1308: Yes or S1508: Yes), the processor 14-3 changes an influence authority that is an authority of the operation regarding the influence for the management user of the second type to a maintaining authority that is an authority not to influence the environment realized by the construction including performing the operation according to the operation content for the operation target resource (for example, S1309 or S1509), and then performs the operation according to the operation content for the operation target resource (for example, S1311 or S1511).

Consequently, it is possible to prevent the unintended influence of one of the self-management user and the managed management user due to a resource operation by the other management user. Thus, both the self-management user and the managed management user can perform the operation without worrying about an operation mistake.

The maintaining authority may be a reference authority (for example, “Read Only”) that is an authority to permit only reference. Since the update does not run, the unintended influence can be prevented.

The influence authority may be an authority of the operation for the influenced resource that is the system resource included in the environment constructed by the management user of the second type (see, for example, the determination A or determination C described above). The influenced resource may be the system resource that meets a condition regarding the relationship with the operation target resource. Consequently, it is possible to prevent the unintended influence from occurring in the existing operation environment including the influenced resource. Note that, the “condition” referred to in this paragraph may be determined by at least one of the designated operation target resource and operation content, and the configuration of the operation environment including the operation target resource. For example, a condition management table representing a condition for corresponding to the influenced resource for each operation environment configuration (in other words, a processing method) may be stored in the management computer 110-3. For example, in S1306 or S1506, the processor 14-3 may specify a condition corresponding to the operation environment configuration including the operation target resource from the configuration management table 404 and the condition management table, and may specify, as the influenced resource, the system resource associated with the operation target resource to satisfy the condition. Consequently, the influenced resource can be narrowed down in accordance with the operation environment configuration.

The influence authority may be an authority of the operation for the configuration in which the construction cannot be performed by the management user of the second type when the operation according to the operation content is performed on the operation target resource (see, for example, the determination B or determination D described above). Consequently, it is possible to avoid an influence on future an operation environment construction.

The example as in the first embodiment may be adopted. That is, the first type may be the managed management user. The second type may be the self-management user. The interface device 11-3 may be a device communicating with the first management computer 110-1. The first management computer 110-1 is a computer for performing the self-management of the first storage device by the self-management user, and may be a computer for performing the operation according to the operation authority regarding the system resource for the management user associated with the system resource in the first storage device. The processor 14-3 may cause the first management computer 110-1 to execute changing the influence authority to the reference authority, and may update information indicating whether or not the managed management is performed on the operation target resource in the resource management information to information indicating that the managed management is performed (for example, “True”). Consequently, it is possible to prevent the occurrence of the unintended influence of the managed management user due to the resource operation by the self-management user.

The example as in the second embodiment may be adopted. That is, the first type may be the self-management user. The second type may be the managed management user. The interface device 11-3 may be a device communicating with the second management computer 110-2. The second management computer 110-2 is a computer for performing the managed management of the second storage device by the managed management user, and may be a computer for performing the operation according to the operation authority regarding the system resource for the management user associated the system resource in the second storage device. The processor 14-3 may cause the second management computer 110-2 to execute changing the influence authority to the reference authority, and may update information indicating whether or not the managed management is performed on the operation target resource in the resource management information to information indicating that the managed management is not performed (for example, “False”). Consequently, it is possible to prevent the occurrence of the unintended influence of the self-management user due to the resource operation by the managed management user.

The processor 14-3 may receive the designation of the managed resource that is the target resource of the operation in the managed management and the operation content for the managed resource from the managed management user. In a case where the processor 14-3 specifies that the managed resource is the system resource also managed by the self-management user from the user management information and the resource management information, specifies that the operation according to the operation content for the managed resource influences the storage management by the self-management user, and specifies that there is the authority change permission from the self-management user, the authority of the operation regarding the influence may be changed to the update authority that is the authority to permit the update for the self-management user, the operation according to the operation content may be performed on the managed resource, and information indicating whether or not the managed management is performed on the managed resource in the resource management information may be updated to information indicating that the managed management is performed. Consequently, it is possible to change the authority after the permission of the self-management user is confirmed for the resource that can be operated by the self-management user although the resource can be originally operated only by the managed management user.

The first type may be the managed management user. The second type may be the self-management user. The first storage device may be the on-premises storage device. The second storage device may be the cloud (for example, public cloud or private cloud) storage device. The operation target resource may be a first logical volume (for example, Vol 2 in FIG. 1) in the first storage device. The first logical volume may be paired with a second logical volume (for example, Vol 3 in FIG. 1) in the first storage device, and data may be copied from the first logical volume to the second logical volume. The second logical volume is a virtual logical volume of a third logical volume (for example, Vol 4 in FIG. 1) included in the second storage device, and input and output (I/O) to and from the second logical volume may be performed with respect to the third logical volume. The change to the reference authority may be a change for the first logical volume.

What is claimed is:

1. A management computer of a storage system, comprising:
an interface device;
a memory device; and
a processor connected to the interface device and the memory device, wherein
the storage system includes a first storage device having a plurality of system resources and a second storage device having a plurality of system resources,
the first storage device is a storage device as a target of self-management,
the self-management is storage management by a self-management user,
the self-management user is a purchaser or a user of the first storage device or a person belonging to the purchaser or the user,
the second storage device is a storage device as a target of managed management,
the managed management is storage management by a managed management user,
the managed management user is a vendor of the second storage device or a person belonging to the vendor,
the memory device stores user management information and resource management information,
the user management information is information indicating whether a type of the management user is the self-management user or the managed management user for each management user,
the resource management information is information indicating which management user manages and whether or not to perform the managed management for each system resource, and
the processor is configured to
receive designation of an operation content and an operation target resource from a management user of a first type, and
change an influence authority that is an authority of an operation regarding an influence for a management user of a second type to a maintaining authority that is an authority not to influence an environment realized by construction including performing an operation according to the operation content for the operation target resource and then perform the operation according to the operation content for the operation target resource in a case where the processor specifies that the operation target resource is a system resource managed by the management user of the second type from the user management information and the resource management information, specifies that the operation according to the operation content for the operation target resource influences storage management by the management user of the second type, and specifies that there is authority change permission from the management user of the second type.

2. The management computer according to claim 1, wherein
the maintaining authority is a reference authority that is an authority to permit only reference.

3. The management computer according to claim 1, wherein
the influence authority is an authority of an operation for an influenced resource that is a system resource included in an environment constructed by the management user of the second type, and
the influenced resource is a system resource satisfying a condition regarding a relationship with the operation target resource.

4. The management computer according to claim 3, wherein
the condition is determined by at least one of the designated operation target resource and operation content and a configuration of an operation environment including the operation target resource.

5. The management computer according to claim 1, wherein
the influence authority is an authority of an operation for a configuration in which construction is impossible by the management user of the second type when the operation according to the operation content is performed on the operation target resource.

6. The management computer according to claim 1, wherein
the first type is the managed management user,
the second type is the self-management user,
the interface device is a device communicating with a first management computer,
the first management computer is a computer for performing the self-management of the first storage device by the self-management user, the computer being used for performing an operation according to an operation authority regarding a system resource in the first storage device for a management user associated with the system resource,
the maintaining authority is a reference authority that is an authority to permit only reference, and
the processor is configured to
cause the first management computer to execute changing the influence authority to the reference authority, and
update information indicating whether or not the managed management is performed on the operation target resource in the resource management information to information indicating that the managed management is performed.

7. The management computer according to claim 1, wherein
the first type is the self-management user,
the second type is the managed management user,
the interface device is a device communicating with a second management computer,
the second management computer is a computer for performing the managed management of the second storage device by the managed management user, the computer being used for performing an operation according to an operation authority regarding a system resource in the second storage device for a management user associated with the system resource,
the maintaining authority is a reference authority that is an authority to permit only reference, and
the processor is configured to
cause the second management computer to execute changing the influence authority to the reference authority, and
update information indicating whether or not managed management is performed on the operation target resource in the resource management information to information indicating that the managed management is not performed.

8. The management computer according to claim 1, wherein
the processor is configured to
receive designation of a managed resource that is a target resource of an operation in the managed management and an operation content for the managed resource from the managed management user, and
change an authority of an operation regarding an influence for the self-management user to an authority to permit update, perform an operation according to the operation content for the managed resource, and update information indicating whether or not the managed management is performed on the managed resource in the resource management information to information indicating that the managed management is performed in a case where the processor specifies that the managed resource is a system resource also managed by the self-management user from the user management information and the resource management information, specifies that the operation according to the operation content for the managed resource influences storage management by the self-management user, and specifies that there is authority change permission from the self-management user.

9. The management computer according to claim 1, wherein
the first type is the managed management user,
the second type is the self-management user,
the maintaining authority is a reference authority that is an authority to permit only reference,
the first storage device is an on-premises storage device,
the second storage device is a cloud storage device,
the operation target resource is a first logical volume in the first storage device,
the first logical volume is paired with a second logical volume in the first storage device, and data is copied from the first logical volume to the second logical volume,
the second logical volume is a virtual logical volume of a third logical volume included in the second storage device, input and output (I/O) to and from the second logical volume are performed on the third logical volume, and
the change to the reference authority is change for the first logical volume.

10. A management method of a storage system, the storage system including
a first storage device having a plurality of system resources and a second storage device having a plurality of system resources,
the first storage device being a storage device as a target of self-management,
the self-management being storage management by a self-management user,
the self-management user being a purchaser or a user of the first storage device or a person belonging to the purchaser or the user,
the second storage device being a storage device as a target of managed management, and
the managed management is storage management by a managed management user, and the managed management user being a vendor of the second storage device or a person belonging to the vendor,
the management method comprising:
receiving, by a computer, designation of an operation content and an operation target resource from a management user of a first type, and
changing, by the computer, an influence authority that is an authority of an operation regarding an influence for a management user of a second type to a maintaining authority that is an authority not to influence an environment realized by construction including performing an operation according to the operation content for the operation target resource and then performing the operation according to the operation content for the operation target resource in a case where the computer specifies that the operation target resource is a system resource managed by the management user of the second type from user management information and resource management information, specifies that the operation according to the operation content for the operation target resource influences storage management by the management user of the second type, and specifies that there is authority change permission from the management user of the second type, wherein
the user management information is information indicating whether a type of the management user is the self-management user or the managed management user for each management user, and
the resource management information is information indicating which management user manages and whether or not to perform the managed management for each system resource.
